(19) United States
(12) Patent Application Publication
(10) Pub. No.: US 2008/0064815 A1
(43) Pub. Date: Mar. 13, 2008

(54) Reinforcement and Cure Enhancement of Curable Resins

(75) Inventors: Bahram Issari, Glastonbury, CT (US); Michael Levandoski, Bristol, CT (US); Richard Corrao, Manchester, CT (US)

Correspondence Address: LOCTITE CORPORATION, 1001 TROUT BROOK CROSSING, ROCKY HILL, CT, 06067, US

(73) Assignee: Henkel Corporation

(21) Appl. No.: 11/530,943

(22) Filed: Sep. 12, 2006

(51) Int. Cl. C08F 8/00

(52) U.S. Cl. 525/100

(57) ABSTRACT

The present invention relates to curable compositions which contain acrylate monomers as liquid filler materials, which when cured, phase separate from the matrix in which they are present and serve as reinforcement materials. The curable compositions possess improved physical properties. Additionally provided are methods of making and using the inventive compositions

### BACKGROUND OF THE INVENTION

1. Field of the Invention

The present invention relates to curable compositions which contain acrylate monomers as liquid filler materials, which when cured phase separate from the matrix in which they are present and serve as reinforcement materials. The curable compositions possess improved physical properties. Additionally provided are methods of making and using the inventive compositions.

2. Brief Description of Related Technology

Silicone compositions are widely used for a variety of applications, including acting as an adhesive and forming gaskets. Various methods have been used in attempts to improve the physical characteristics of the polymer compositions. For example, in polyurethane chemistry, the polymer backbones are sometimes designed to have hard and soft segments with the understanding that during the cure process phase separation of hard and soft blocks occurs with one block becoming the discontinuous phase relative to the other block and providing property enhancement to the overall composition.

Another known approach to improve the properties of silicone compositions has been via the addition of certain solid fillers to the silicone compositions. Solid fillers such as fumed silica are frequently added to silicone compositions to modify the physical characteristics of the compositions. However, there are a number of drawbacks associated with the use of solid fillers. Incorporation of solid fillers may impact negatively on the stability of the silicone compositions due to side reactions, thus affecting the cure process and/or the viscosity of the silicone compositions. For example, the silicone composition might end up gelling if it reacts with the solid filler.

Additionally, solid fillers frequently prevent radiation such as light from traveling through the composition, thereby hindering the cure process. Moreover, as is the case with many solid fillers, the cost of the particles themselves can be prohibitively expensive.

The amount of solid fillers directly added to silicone compositions is limited by the change in viscosity that occurs due to the filler. When solid filler is directly added at weights greater than 20% by weight of the total composition, the silicone composition typically becomes too viscous (in the 400,000 to 500,000 centipoise range) to be used conveniently. Moreover, tensile strength in such cases frequently peaks in the 600 to 700 psi range.

However, at low levels of addition of acrylate monomers, such as from about 5% to about 10% by weight of the entire composition, incompatibility issues have been encountered. Based on these findings, it has logically been understood that further increases in the amounts of acrylate monomer used would result in greater instability of the composition, or increased haziness due to the incompatibility of the acrylate monomer and silicone. Such prior low levels of acrylate provided no indication of property changes.

For example, U.S. Pat. No. 6,627,672 to Lin makes use of a silicone and acrylate monomer composition, with acylphosphine oxide added to achieve greater cure through volume of the composition when exposed to curing conditions. Lin uses the acrylate to help dissolve the phosphine oxide curing agent into formulation.

### SUMMARY OF THE INVENTION

One aspect of the invention relates to the use of liquid (meth)acrylate monomers as “liquid fillers” in a curable matrix. The term “liquid filler” is intended to mean those (meth)acrylate monomers, which when added to a curable matrix and subjected to cure conditions, form into a solid phase within the polymer matrix, which prior to cure may be solid or liquid. This co-curing of the liquid filler along with the curable matrix results in a two phase system. The solidified liquid filler is dispensed within the cured matrix and serves to impart a variety of properties to the final product, including enhanced physical properties such as tensile strength, toughness and elongation. The improvement in elongation is considered significant in that it is contrary to the effect seen in conventional addition of solid fillers to curable polymer compositions. In conventional solid filler additives, tensile strength may be increased, but elongation values typically decrease. This additional structural enhancement has significant advantages.

It has been discovered that as the (meth)acrylate monomer cures, it phase separates and becomes a solid filler which reinforces the polymer matrix in which it is dispersed. While in the liquid form prior to cure, the liquid filler and the matrix components are generally miscible with each other and are present in a substantially single phase. However, after cure the matrix is essentially a cured polymer phase containing a solidified liquid (meth)acrylate phase dispersed therein.

In some aspects of the invention, the curable matrix is a non-(meth)acrylate matrix, such as a silicone, a urethane, an epoxy or a polymer containing silicone, urethane or epoxy linkages. In some aspects of the invention, the matrix is a (meth)acrylate matrix, such as a urethane methacrylate polymer.

As noted above, based on incompatibility issues between acrylates and silicones, previous efforts were not undertaken because of the general understanding that addition of acrylate monomers to silicone compositions in amounts greater than about 10% by weight of the total composition would present the resulting composition with instability and compatibility issues. By the present invention, however, it was discovered that once the acrylate monomer and silicone were each cured, the resulting phase separation provided the cured reaction product with unique and improved physical properties. It has been surprisingly discovered by the present invention that the addition of curable liquid acrylate monomers to curable polymer matrices including, without limitation, silicones, urethanes, epoxies and poly(meth)acrylates, in amounts ranging from about 15% to about 60% by weight of the total composition resulted in marked improvement in physical properties of the cured compositions, including improved elongation and tensile strength. Also unexpected was the high degree of compatibility of the acrylate monomer mixed in such large amounts with the curable polymer matrices in the curable compositions. Use of the acrylate monomers with low viscosity will allow the viscosity of the inventive composition to be more easily tailored to application requirements by balancing monomer and filler levels in the composition.

In one aspect of the invention there is provided a curable composition which includes:

a) a curable polymer non-(meth)acrylate based matrix; and

b) a liquid (meth)acrylate monomer, which when co-cured with the matrix, forms a separate phase from said matrix and/or serves as a filler.

Desirably, the non-(meth)acrylate based matrix is a silicone composition, a urethane composition, an epoxy composition, a polyacrylate composition, a polyester composition or a mixture or copolymer of any of these.

Another aspect of the invention relates to admixing the above components (a) and (b) to form the inventive curable compositions, and further, curing the composition to form the reaction products of components (a) and (b), described above.

In another aspect of the present invention, there is provided a composition which includes:
a) a silicone component; and
b) a (meth)acrylate monomer present in an amount of at least about 5%, desirably at least about 10% and more desirably at least about 15% by weight of the total composition;

where the composition is free of an acylphosphine oxide.

In another aspect of the present invention, there is provided a method for producing a composition, the method including mixing:
a) a silicone component; and
b) a (meth)acrylate monomer present in an amount of at least about 5%, desirably at least about 10% and more desirably at least about 15% by weight of the total composition;

where the composition is free of an acylphosphine oxide.

In a further aspect of the present invention, there is provided a method of using a composition which includes:
a) providing the composition comprising;
   i) a silicone component; and
   ii) a (meth)acrylate monomer present in an amount of at least about 5% by weight of the total composition;

where the composition is free of an acyiphosphine oxide;
b) applying the composition onto a substrate; and
c) exposing the composition to conditions appropriate to cure the composition.

In yet a further aspect of the invention there is provided a composition including:
a) a silicone component; and
b) a (meth)acrylate monomer present in amounts of at least about 40% by weight of the total composition.

It has also been discovered that liquid acrylate monomers can serve as in situ-formed fillers for acrylate systems as well. Thus, in yet another aspect of the invention there is provided a composition which includes:
a) a polyacrylate monomer matrix; and
b) a liquid (meth)acrylate monomer filler present in amounts of about 5% to about 60% by weight of the total composition.

A composition comprising the reaction product of a curable liquid polyacrylate matrix and a curable liquid acrylate monomer filler is also provided by the present invention. This composition includes as a first phase a cured polyacrylate matrix and having dispersed therein a second phase comprising a cured acrylate monomer.

A further aspect of the invention includes a method of making a filler reinforced composition which includes:
a) providing a matrix comprising a curable resin and a curable liquid acrylate miscible therein; and
b) exposing the matrix to conditions suitable to cure both the curable resin and the liquid acrylate, where upon cure the liquid acrylate and cured resin form separate phases.

In another aspect of the invention there is provided a method of providing structural reinforcement to a composition which includes the steps of:
a) providing a liquid (meth)acrylate monomer;
b) providing a curable polymer matrix;
c) combining the liquid (meth)acrylate monomer and the curable polymer matrix to form a curable composition; and
d) curing the curable composition, whereby at least one of the following properties of the composition once cured are increased: tensile strength; elongation at break; tear strength or Shore A hardness.

In still yet another aspect of the invention there is provided a method of reshaping a cured composition which includes the steps of:
a) providing a liquid (meth)acrylate monomer;
b) providing a curable polymer matrix;
c) combining the liquid (meth)acrylate monomer and the curable polymer matrix to form a curable composition and curing the curable composition;
d) heating the cured composition to a temperature above the glass transition temperature (“Tg”) of the monomer but below the Tg of the polymer,
e) changing the shape of the cured composition and maintaining that changed shape until the monomer resolidifies, whereby the cured composition maintains its changed shape.

### BRIEF DESCRIPTION OF THE DRAWINGS

FIG. 1 shows a dynamic mechanical analysis curve for four compositions of the invention—B1, B3, B6 and B8.

FIGS. 2 and 3 show photomicrographs of atomic force microscopy (“AFM”) derived topography and phase images for inventive samples and control samples. FIG. 1, shows an expressed surface of each sample, whereas FIG. 3 shows a cross sectional of those samples.

FIG. 4 is a schematic diagram of AFM equipment measuring a material having more than one phase as shown by the differences in elasticity or adhesion measurements (signals).

### DETAILED DESCRIPTION OF THE INVENTION

The present invention provides curable compositions which possess enhanced physical characteristics due to the incorporation of a curable liquid filler. The liquid filler is generally miscible in the curable matrix and when cured along with the curable matrix, a multi-phase solid forms due to phase separation. The cured liquid filler is dispersed in the matrix and serves to enhance physical properties of the total composition. The resin matrix of the compositions is desirably crosslinked when cured, in contrast to the cured liquid fillers, which are desirably thermoplastic when cured. In some embodiments, however, the liquid acrylate fillers may also be crosslinked and/or partially incorporated into the matrix.

As used herein, the terms “hydrocarbon radical” and “hydrocarbon diradical” are intended to refer to radicals and diradicals, respectively, which are primarily composed of carbon and hydrogen atoms. Thus, the terms encompass aliphatic groups such as alkyl, alkenyl, and alkynyl groups; aromatic groups such as phenyl; and alicyclic groups such as cycloalkyl and cycloalkenyl. Hydrocarbon radicals of the invention may include heteroatoms to the extent that the heteroatoms do not detract from the hydrocarbon nature of the groups. Accordingly, hydrocarbon groups may include such functionally groups as ethers, alkoxides, carbonyls, esters, amino groups, cyano groups, sulfides, sulfates, sulfoxides, sulfones, and sulfones.

The hydrocarbon, alkyl, and phenyl radicals and diradicals of the present invention may be optionally substituted. As used herein the term “optionally substituted” is intended to mean that one or more hydrogens on a group may be replaced with a corresponding number of substituents selected from alkyl, alkenyl, alkynyl, aryl, halo, haloalkyl, haloalkenyl, haloalkynyl, haloaryl, hydroxy, alkoxy, alkenyloxy, alkynyloxy, aryloxy, carboxy, benzyloxy, haloalkoxy, haloalkenyloxy, haloalkynyloxy, haloaryloxy, nitro, nitroalkyl, nitroalkenyl, nitroalkynyl, nitroaryl, nitroheterocyclyl, azido, amino, alkylamino, alkenylamino, alkynylamino, arylamino, benzylamino, acyl, alkenylacyl, alkylacyl, arylacyl, acylamino, acyloxy, aldehydo, alkylsulphonyl, aryisulphonyl, alkylsulphonylamino, arylsulphonylamino, alkylsulphonyloxy, arylsulphonyloxy, heterocyclyl, heterocycloxy, helerocyclylamino, haloheterocyclyl, alkylsulphenyl, arylsulphenyl, carboalkoxy, carboaryloxy, mercapto, alkylthio, arylthio, acylthio and the like.

As used herein, the term “(meth)acrylate” is intended to include methacrylates and acrylates, and reference to one of methacrylates or acrylates is intended to embrace the other as well, unless specifically noted otherwise.

As used herein, the terms “halo” and “halogen” are intended to be synonymous, and both are intended to include chlorine, fluorine, bromine, and iodine.

For purposes of this invention, scientific symbols and terms which are otherwise not defined, such as Tg, have their commonly accepted meaning.

In certain aspects of the invention, acylphosphine oxide is deliberately not included.

The incorporation of the (meth)acrylate monomer (here liquid filler) in to the curable matrix composition, followed by the curing of the (meth)acrylate leads to phase separation of the cured acrylate within the matrix composition, thereby forming (meth)acrylate domains in the cured polymer matrix composition. These domains may vary in size from micro domains which are not easily observable, to domains which are visible by observation. The presence of domains indicate the presence of another phase separate from the matrix. The domains can be detected not only by the change in properties, but also using techniques such as AFM, which is described later herein. These (meth)acrylate domains enhance the physical property of the matrix in a manner similar to solid fillers, without the disadvantages associated with solid fillers. Additionally, a number of benefits are provided by using the acrylate monomers, and particularly in amounts greater than 30%, which are not provided by using solid fillers.

For example, the use of a traditional solid filler may adversely affect the composition's ability to undergo radiation cure. This problem is largely avoided by the inventive compositions because the liquid (meth)acrylate monomer filler permits penetration of photo radiation. Moreover, because the liquid fillers have been formed to be miscible in the matrix, greater quantities can be added to the matrix to better control and tailor the final properties.

### Liquid (Meth)Acrylate Monomer Fillers

The polymerizable liquid (meth)acrylate fillers may be selected from a wide variety of compounds. A desirable class of polymerizable (meth)acrylates useful as liquid fillers in the invention include poly- and mono-functional (meth)acrylate esters. One class of polymerizable (meth)acrylate esters useful in the present invention have the general structure:

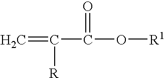

where R is H, halogen, and C₁ to C₂₀ hydrocarbyl; and R¹ is H or C₁ to C₂₀ hydrocarbyl. Desirably R¹ is at least C₁₀ or greater.

Other desirable polymerizable acrylate esters useful in the present invention as liquid fillers are urethane acrylates having the general structure:

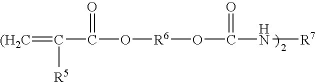

where R⁵ is H, C₁ to C₄ alkyl, or halogen; R⁶ is (i) a C₁ to C₈ hydroxyalkylene or aminoalkylene group, (ii) a C₁ to C₆ alklamino-C₁ to C₈ alkylene, a hydroxyphenylene, aminophenylene, hydroxynaphthalene or amino-naphthalene optionially substituted by C₁ to C₃ alkyl, C₁ to C₃ alkylamino or di-C₁ to C₃ alkylamino group; and R⁷ is C₂ to C₂₀ alkylene, C₂ to C₂₀ alkenylene or C₂ to C₂₀ cycloalkylene, C₆ to C₄₀ arylene, alkarylene, C₂ to C₄₀ aralkarylene, C₂ to C₄₀ alkyloxyalkylene or C₂ to C₄₀ aryloxyarylene optionally substituted by 1-4 halogen atoms or by 1-3 amino or mono- or di-C₂₁ to C₃ alkylamino or C₁ to C₃ alkoxy groups.

Other desirable acrylate ester monomers useful as liquid fillers, include, without limitation, urethane acrylates within the general structure:

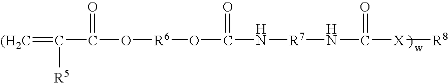

where R⁵, R⁶, and R⁷ are as described herein above; R⁸ is a non-functional residue of a polyamine or a polyhydric alcohol having at least n primary or secondary amino or hydroxy groups respectively; X is O or NR⁹ where R⁶ is H or C₁ to C₇ alkyl; and w is an integer from 2 to 20.

Among the specific monofunctional polymerizable acrylate esters which are useful as liquid fillers and which are particularly desirable, include isobornyl acrylate, adamantly acrylate, dicyclopentenyl acrylate, trimethylcyclohexyl acrylate, cyclohexyl(meth)acrylate, isooctyl acrylate, isodecyl acrylate, 2(2-ethoxyethoxy)ethylacrylate, and combinations thereof

Advantageously, the acrylate ester monomer may be isobornyl acrylate, particularly because it has a Tg above room temperature (above 23° C.) and thus serves to improve and enhance the physical properties above room temperature. Iso-octyl acrylate, isodecyl 2(2-ethyxyethoxy) ethylacrylate each have a Tg below room temperature and thus are most useful for applications where temperatures are less than room temperature, but greater than their respective Tg's.

Specific polyfunctional monomers which are desirable include polyethylene glycol dimethacrylate and dipropylene glycol dimethaerylate.

Other desirable polymerizable acrylate esters useful as liquid fillers in the invention are selected from the acrylate, methacrylate and glycidyl methacrylate esters of bisphenol A. Desirable among these free-radical polymerizable components mentioned is ethoxylated bisphenol-A-dimethacrylate (“EBIPMA”).

Mixtures or copolymers of any of the above-mentioned liquid acrylate fillers may be employed.

The liquid acrylate filler may be added in amounts of at least about 5% by weight of the total composition. Desirably, the acrylate monomer is present in an amount of at least about 15% to about 60% by weight of the total composition, and more desirably in an amount of about 15% to about 50% by weight of the total composition and even more desirably in amounts of about 20% to about 40% by weight of the total composition. In one aspect, the acrylate monomer is added in an amount of at least about 25% by weight of the total composition. In another aspect, the acrylate monomer is added in an amount of about 40% by weight of the total composition. In yet another aspect, the acrylate monomer is added in an amount of at least about 50% by weight of the total composition.

### Curable Matrices

As previously noted, the curable matrices may be selected from a wide variety of curable materials, among the most desirable of which are silicone, urethane, epoxies, polyesters, poly(meth)acrylates and combinations and copolymers thereof.

Silicone matrices may be selected from any suitable silicone composition. These include silicones which may cure by a variety of mechanisms, including moisture cure, heat cure, free radical cure, radiation cure (such as photoradiation cure including UV, visible, IR, and electromagnetic radiation), without limitation, and combinations thereof. Dual cure, such as moisture and radiation cure, or moisture and heat cure, or even cure by three mechanisms is contemplated. Silicones with acrylate end or pendent groups are contemplated. Silicones with urethane and/or urea linkages are also contemplated. Silicones with epoxy end groups are contemplated.

### Moisture Curable Silicones

In one aspect, a silicone may be capable of moisture cure. A typical moisture cure silicone may be one in which the terminal portions thereof contain moisture cureable groups, such as exemplified in the structure below:

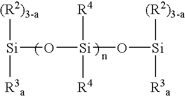

Substituent R² is a hydrolyzable group, which provide the compositions of the present invention with their ability to undergo room temperature vulcanization (“RTV”) cure. RTV cure typically occurs through exposure of the compositions of the invention to moisture. The compositions of the present invention may cure to a flexible resin via a RTV mechanism. The presence of hydrolyzable moisture curing groups permits the polymer to undergo moisture cure. Suitable hydrolyzable groups include alkoxy groups such as methoxy, ethoxy, propoxy, and butoxy; acyloxy groups such acetoxy; aryloxy groups such as phenoxy; oximinoxy groups such as methylethyloximinoxy; enoxy groups such as isopropenoxy; and alkoxyalkyl groups such as CH₃OCH₂CH₂—. Larger groups such as propoxy and butoxy are slower to react than smaller groups such as methoxy and ethoxy. The rate at which the compositions of the present invention undergo moisture cure can be tailored by choosing appropriate groups for substituent R². A mixture of different R² groups can be positioned on a single silicon atom to influence the cure of the composition. Advantageously, R² may be C₁ to C₄ alkyl. More advantageously, R² is methyl or ethyl.

R³ in each occurrence may be the same or different, and is a C₁ to C₁₀ hydrocarbon radical. R³ is advantageously C₁ to C₄ alkyl. More advantageously, R³ is methyl.

R⁴ in each occurrence may be the same or different and is a C₁ to C₁₀ hydrocarbon radical. Advantageously, R⁴ is C₁ to C₄ alkyl. For most commercial applications, R⁴ will desirably be methyl, due to the wide availability of polydimethylsiloxane starting material which is advantageously used in the synthesis of the compositions of the invention. In another desirable aspect, R⁴ may also be phenyl.

The inventive compositions may advantageously include one or more moisture-cure catalysts. The cure system used in the moisture curable compositions of the present invention includes, but is not limited to, catalysts or other reagents which act to accelerate or otherwise promote the curing of the composition of the invention. Suitable moisture-cure catalysts include compounds which contain such metals as titanium, tin, or zirconium. Illustrative examples of the titanium compounds include tetraisopropyl titanate and tetrabutyl titanate. Illustrative examples of the tin compounds include dibutyltin dilaurate, dibutyltin diacetate, dioctyltindicarboxylate, dimethyltindicarboxylate, and dibutyltindioctoate. Zirconium compounds include zirconium octanoate, and zinc compounds include 2-ethylhexanoate, the later which is favored for medical applications which require use of catalysts having minimal cytotoxicity. Additionally, organic amines such as tetramethylguandinamines, diazabicyclo[5.4.0]undec-7-ene (“DBU”), triethylamine, and the like may be used. The moisture-cure catalysts are employed in an amount sufficient to effectuate moisture-cure, which generally is from about 0.01% to about 5.00% by weight, and advantageously from about 0.1% to about 1.0% by weight.

### Radiation and Polymodal Curable Silicones

In another aspect of the present invention, the silicone component may be capable of radiation cure. In a typical radiation, radiation curable silicones may sometimes react with the acrylate, leading to unfavorable physical characteristics. While such reaction is possible with the inventive compositions, it is believed that the acrylate microdomains still form even if the silicone is a radiation or dual cure system.

In still another aspect of the invention, the silicone component may be capable of both radiation and moisture cure. In this case, R³ and R⁴ are as described above for moisture curable silicones. Substituents A and Y below form a group which may be present at the terminal ends of the compositions of the invention, and may also be present as a pendent group along the length of the polymer. The -A-Y group allows the compositions of the present invention to undergo radiation cure. An example of a silicone end-capped on each terminus with the photocurable -A-Y group is shown below:

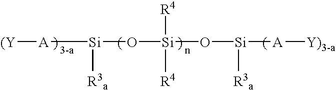

The portion of the -A-Y group denoted by substituent Y, contains at least one functional group capable of free radical polymerization, and is well known to those skilled in the art. Y in each occurrence may be the same or different and contains at least one radiation curable group selected from a double bond, an epoxide ring, or an episulfide ring. Examples of functional groups denoted by substituent Y include, but are not limited to: epoxy, vinyl, alkylvinyl, allylic, alkylallylic, alkylvinyl, alkylalkynyl, and azo. Advantageously, the group denoted by substituent Y is of the formula:

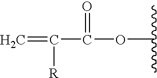

where R is a member selected from H, halogen, and C₁ to C₁₀ hydrocarbyl. This group provides the composition with its ability to undergo radiation cure, heat cure or free radical polymerization. Advantageously, at least two such groups will be present. Advantageously, the group is a (meth)acryloxy group. The term “(meth)acryloxy” is intended to refer to include both acrylate and methacrylate, in which R is H or methyl, respectively. More desirably, the group is methacrylate, i.e., in which R is methyl.

The portion of the -A-Y group denoted by substituent A may be C₁-C₃ alkylene, examples of which include methylene, ethylene, propylene, and isopropylene. A in each occurrence may be the same or different.

In addition to radiation and/or moisture curable silicones, the curable resin matrix may also include heat curable silicones. Typically, these heat curing compositions use hydrosilation catalysts such as platinum, rhodium or other similar catalysts, along with a cross linker to provide cure. As previously noted, the silicone chosen as the matrix may cure using any one or more of the various cure mechanisms. In some instances, mixtures of silicones may be used.

### Poly(Acrylate)Matrices

It has also been discovered that curable polyacrylate matrices can be reinforced with certain curable liquid acrylate fillers, which when cured form separate phases from one another. Similar to the silicone matrices having the cured acrylate phase dispersed therein, the liquid filler acrylates also form separate domains in the polyacrylate matrix to reinforce and improve the physical properties of the total composition. The liquid acrylate fillers are desirably miscible in the polyacrylate matrix.

Useful polyacrylate matrices may be selected from a wide variety of materials.

Polymerizable polyacrylate esters, which may be used in accordance with the present invention, are exemplified by, but not limited to, the following materials: diethylene glycol dimethacrylate, triethylene glycol dimethacrylate, tetraethylene glycol dimethacrylate (“TEGMA”), dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate and trimethylol propane triacrylate. Other acrylates, such as EBIPMA, the reaction product of the diglycidylether of bisphenol A with methacrylic acid, their related compounds and derivatives may also be used. Of these, the preferred monomer is EBIPMA.

Also useful are polyacrylates with pendant functionalities, such as pendent ester groups, including those provided by Kaneka Corporation. For example, RC100C, RC200C and RC220C are among the useful commercially available resins from Kaneka.

### Urethane Matrices

Urethane-acrylates have been found to be a particularly useful polymer matrix. For example, one such material is used by Henkel Corporation in many of its products, and is referred to under the trade name ACRYLFLEX.

Other useful urethane-acrylates include those described in U.S. Pat. No. 3,925,988 to Forman, and U.S. Pat. Nos. 4,309,526 and 5,018,851 to Baccei, et al., the embodiment of each of which is hereby expressly incorporated herein by reference in their entirety. The '526 patent discloses polymerizable block copolymers having rigid and flexible segments. This is achieved by chemical linking of precursor “prepolymers” which are subsequently “capped” with (meth)acrylate functionality.

Other useful urethanes include those described in U.S. Pat. Nos. 6,756,576 and 6,562,881, both to Jacobine et al., the disclosure of each of which hereby being expressly incorporated herein by reference in their entirety.

### Epoxy Matrices

A variety of epoxy matrices are also useful in the invention. For example, U.S. Pat. No. 5,679,719 to Klemarczyk et. al., provides epoxy compositions useful as the inventive matrices, and is hereby expressly incorporated herein by reference in their entirety. Additionally, U.S. Pat. No. 4,892,764 to Drain, et al. discloses useful epoxies and is also hereby expressly incorporated herein by reference in its entirety.

### Cure Systems

The particular cure system chosen will be dictated by the type of matrix used. Some useful matrices will cure by free-radical mechanisms, some by heat cure or photocure, others by a combination of these mechanisms.

For example, if the matrix is a silicone, it may cure by moisture, heat, light, free radical (such as peroxide initiated) or a combination thereof, depending on the makeup of the backbone and pendent or end groups. One or more moisture cure catalysts, photoinitiators, free radical initiators, heat cure catalysts, epoxy catalysts (e.g., amines or imidazoles) may be employed to cure the matrix. Combinations of curing agents may also be employed. The amount of any of the curing agents useful for any of the matrices may range from 0.001% to about 10% and desirably 0.01% to about 3% by weight of the total composition.

A number of photoinitiators may be employed as part of the present invention. Any known free radical type photoinitiator which promotes crosslinking, may be used in present invention. Photoinitiators enhance the rapidity of the curing process when the photocurable compositions as a whole are exposed to electromagnetic radiation.

Non-limiting examples of UV photoinitiators that are useful in the inventive compositions include benzoins, benzophenone, dialkoxy-benzophenones, Michler's ketone (4,4′-bis(dimethylamino)benzophenone) and diethoxyacetophenone.

Examples of suitable photoinitiators for use herein include, but are not limited to, photoinitiators available commercially from Ciba Specialty Chemicals, under the IRGACURE and DAROCUR trade names, specifically IRGACURE 184 (1-hydroxycyclohexyl phenyl ketone), 907 (2-methyl-1-[4-(methylthio)phenyl]-2-morpholino propan-1-one), 369 (2-benzyl-2-N,N-dimethylamino-1-(4-morpholinophenyl)-1-butanone), 500 (the combination of 1-hydroxy cyclohexyl phenyl ketone and benzophenone), 651 (2,2-dimethoxy-2-phenyl acetophenone), 1700 (the combination of bis(2,6-dimethoxybenzoyl-2,4,4-trimethyl pentyl)phosphine oxide and 2-hydroxy-2-methyl-1-phenyl-propan-1-one), and 819 [bis(2,4,6-trimethyl benzoyl)phenyl phosphine oxide] and DAROCUR 1173 (2-hydroxy-2-methyl-1-phenyl-1-propan-1-one) and 4265 (the combination of 2,4,6-trimethylbenzoyldiphenyl-phosphine oxide and 2-hydroxy-2-methyl-1-phenyl-propan-1-one); and the visible light [blue] photoinitiators, dl-camphorquinone and IRGACURE 784DC. Of course, combinations of these materials may also be employed herein.

Other photoinitiators useful herein include alkyl pyruvates, such as methyl, ethyl, propyl, and butyl pyruvates, and aryl pyruvates, such as phenyl, benzyl, and appropriately substituted derivatives thereof. Photoinitiators particularly well-suited for use herein include ultraviolet photoinitiators, such as 2,2-dimethoxy-2-phenyl acetophenone (e.g., IRGACURE 651), and 2-hydroxy-2-methyl-1-phenyl-1-propane (e.g., DAROCUR 1173), bis(2,4,6-trimethyl benzoyl) phenyl phosphine oxide (e.g., IRGACURE 819), and the ultraviolet/visible photoinitiator combination of bis(2,6-dimethoxybenzoyl-2,4,4-trimethylpentyl) phosphine oxide and 2-hydroxy-2-methyl-1-phenyl-propan-1-one (e.g., IRGACUIRE 1700), as well as the visible photoinitiator bis(η⁵-2,4-cyclopentadien-1-yl)-bis-[2,6-difluoro-3-(1H-pyrrol-1-yl)phenyl] titanium (e.g, IRGACURE 784DC).

The amount of photoinitiator used in the composition will typically be in the range of between about 0.1% to about 10% of the composition, and desirably from about 2% to about 5% by weight of the composition. Depending on the characteristics of the particular photoinitiator, however, amounts outside of this range may be employed without departing from the invention so long as they perform the function of rapidly and efficiently initiating polymerization of the photocurable groups.

The radiation which cures the inventive compositions may include UV and/or visible light. For visible light radiation, light-emitting diode (“LED”) based light generation devices may be employed. Such devices include at least one LED coupled to a power supply, which device delivers a high light output to the compositions to be cured.

Examples of light sources that can provide both UV and visible light include arc lamps. Conventional arc lamps such as mercury short arc lamps may be employed. UV curing lamp assemblies, which may include arc lamps, such as those disclosed in U.S. Pat. Nos. 6,520,663 and 6,881,964 each to Holmes, the disclosure of each of which being hereby expressly incorporated herein by reference in their entirety, may be used.

An example of a commercially available lamp assembly useful for UV and/or visible light curing is the ZETA 7420 (available from Henkel Corporation, Rocky Hill, Conn.). The ZET A 7420 includes a glass filter to reduce short and medium wavelength lamp emissions. The assembly can emit light in the visible blue and green region.

Any moisture curing catalyst may be used to cure moisture curing matrices of the invention. For example, organo tin compounds, such as dibutyltindilaurate (“DBTDL”), dibutyltin acetylacetonate (“ULA-45”), dimethyltindilaurate, tetrabutyldiaceloxystannoxane (“TBDAS”) and dimethyltindichloride are among the more desirable organo tin compounds. The catalysts are used in amounts of about 10% by weight of the total composition.

Useful amine catalysts include, without limitation, those recited in U.S. Pat. No. 4,092,443 to Green et al., the disclosure of which is hereby expressly incorporated herein by reference in its entirety. Of particular usefulness are the primary and secondary amines, although tertiary amines are also useful.

Useful imidazole curing agents include, without limitation, those recited in U.S. Pat. No. 5,679,719, which is expressly incorporated herein in its entirety by reference. For example, 2-ethyl-4-methyl imidazole, 1-(2-cyanomethyl)-2-ethyl-4-methyl imidazole and 2-phenyl-4,5-dihydroxymethyl imidazole; aliphatic cycloaliphatic amines, preferably 2,2′dimethyl-4,4′-methylene-bis(cyclohexylamine) (ANCAMINE 2049); aromatic amines, preferably 4,4′-diaminodiphenyl sulfone (ANCAMINE S and ANCAMINE SP); a blend of aromatic and aliphatic amines (ANCAMINE 2038); dissociable amine sales, Lewis Acid catalysts such as boron trifluoride:amine complexes, preferably BF₃:benzyl amine (ANCHOR 1907), BF₃:monoethyl amine (ANCHOR 1948) and liquid BF₃:amine complex (ANCHOR 222); Lewis Base catalysts such as t-amines, preferably tris(dimethyl-aminomethyl)phenol (ANCAMINE K54), dimethylaminomethyl phenol (ANCAMINE 1110); dicyandiamides, preferably dicyandiamide (AMICURE CG). The ANCAMINE, ANCHOR, and AMICURE series are trade names for heat activated curing agents available commercially from Pacific Anchor Performance Chemicals Division of Air Products and Chemicals, Inc.

### Additional Additives

A variety of additional useful components may be included in the present inventive compositions. For example, condensable silanes may be added to facilitate chain-extension, and in certain cases can effectuate cross-linking. Such condensable silanes include alkoxy silanes, acetoxy silanes, enoxy silanes, oximino silanes, amino silanes and combinations thereof Other suitable silanes include vinyl trimethoxy silane, vinyltrimethoxysilane, vinyltriisopropenoxysilane, and alpha functionalized silanes.

Accordingly, a further aspect of the invention relates to the cross-linked polymer formed by reaction of the compositions of the invention upon exposure to moisture. The condensable silanes may be present in amounts of about 0.5% to about 10% by weight of the composition.

Adhesion promoters also may be included in the moisture curable compositions. An adhesion promoter may act to enhance the adhesive character of the moisture curable composition for a specific substrate (i.e, metal, glass, plastics, ceramic, and blends thereof). Any suitable adhesion promoter may be employed for such purpose, depending on the specific substrate elements employed in a given application. Various organosilane compounds, particularly aminofunctional alkoxysilanes, may be desired.

Suitable organosilane adhesion promoters include, for example, 3-aminopropyltriethoxysilane, 3-aminopropyltrimethoxysilane, 3-aminopropylmethyldiethoxysilane, 3-aminopropylmethyldimethoxysilane, methylaminopropyltrimethoxysilane, 1,3,5-tris(trimethylsilylpropyl)isocyanurate, 3-glycidoxypropyltrimethoxysilane, 3-glycidoxypropylethyldinethoxysilane, 2-glycidoxyethyltrimethoxysilane, 2-cyanoethyltrimethoxysilane, 3-cyanopropyltriethoxysilane, isocyanatopropyltriethoxysilane, isocyanatopropyltrimethoxysilane, and combinations thereof.

Adhesion promoters, when present, may be used in amounts of about 0.1% to about 10% by weight of the composition. Desirably, the adhesion promoter is present from about 0.2% to about 2.0% by weight of the composition.

The compositions also may include any number of optional additives, such as pigments or dyes, plasticizers, thixotropic agents, alcohol scavengers, stabilizers, anti-oxidants, flame retardants, UV-stabilizers, biocides, fungicides, thermal stabilizing agents, rheological additives, tackifiers, and the like or combinations thereof. These additives should be present in amounts suitable to effectuate their intended purpose.

The present invention further provides a method for producing a composition, the method including mixing:
a) a silicone component; and
b) a (meth)acrylate monomer present in an amount of at least about 5% by weight of the total composition;
   where the composition is free of an acylphosphine oxide, and where the silicone component and acrylate monomer are as discussed hereinabove.

Also provided is a method of using the inventive composition, the composition including:
a) a silicone component; and
b) a (meth)acrylate monomer present in an amount of at least about 5% by weight of the total composition;
   where the composition is free of an acyiphosphine oxide; and

the method including the steps of:
a) providing the composition:
b) applying the composition onto a substrate; and
c) exposing the composition to conditions appropriate to cure the composition,
   where the silicone component and the acrylate monomer are as discussed hereinabove.

The composition is useful in many applications, such as bonding together substrates, at least one of which is constructed of a metal or a synthetic material. Examples of such metals include steel and aluminum; and of the synthetic materials are of glass cloth phenolics and phenolic composites.

The inventive compositions may be used, for example, to seal or bond substrates or may be used to form gaskets. In gasketing applications, the moisture curable composition may be applied to one of the substrates which will form part of the gasket, cured or at least partially cured, and then joined to a second substrate to form a gasket assembly. Such gasketing application include, for example, form-in-place gaskets.

The present invention also provides processes for using the inventive compositions to bond together two substrates. For instance, in one such process, the composition is applied onto a surface of a first substrate, and thereafter a surface of a second substrate is mated in abutting relationship with the composition-applied first substrate to form an assembly. The mated assembly is then maintained in the abutting relationship, and exposed to conditions of cure, for at least a time sufficient to allow the composition to cure.

In an alternative process, the composition is applied onto a surface of at least one of a first substrate or a second substrate, and each of the composition-applied substrate(s) is maintained away from the other substrate, and exposed to conditions or cure, for at least a time sufficient to allow the composition to cure. Then, the substrates are mated in abutting relationship to form an assembly.

In yet another alternative process, a first substrate is mated in spaced apart relationship with a second substrate, and within the space the composition is applied or dispensed. The assembly of the first substrate and the second substrate is then maintained in the relationship, and exposed to conditions of cure, for at least a time sufficient to allow the composition to cure.

Another area in which the inventive compositions are particularly useful is that of shape memory. Shape memory allows the matrix to be shaped, when at a temperature above the compositions Tg of the acrylate filler. Upon heating the cured composition above the Tg of the cured acrylate filler, the acrylate softens and can be shaped. The polymeric matrix, particularly silicone matrices, is desirably elastomeric. Upon cooling below the Tg of the acrylate, the silicone is forced to maintain the shape by the solidification of the acrylate. On cooling below the Tg, the shape will be maintained by the phase separated cured acrylate monomer. On re-warming to a temperature above the Tg, the matrix will be able to return to its original shape. This process can be continued.

Shape memory is also a way of storing energy; i.e., the solid matrix may be elastically deformed and elongated when above the Tg of the acrylate monomer and held in that shape until the temperature is reduced to a point below the acrylate monomer's Tg value. The solid will then remain in the deformed or elongated shape with stored energy in the form of spring elongation of the silicone matrix. On warming to the Tg point of the acrylate monomer, the lock on the silicone portion of the matrix will be released and the silicone will return to its original form while releasing energy. This “pull-back” can be designed for such tasks as operating switches.

The choice of liquid acrylate filler will dictate the Tg value and hence the temperature at which this process can be carried out. Furthermore, by using acrylate monomers that have functional groups such as the double bond of dicyclopentadienyl acrylate, the phase-separated structure can be made to cross-link, and would no longer provide the same Tg characteristics.

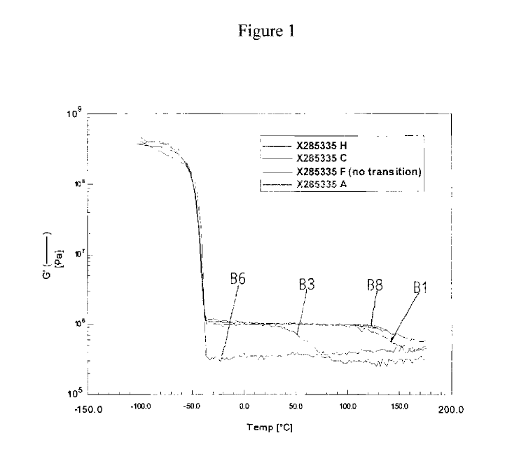

With regard to FIG. 1, dynamic mechanical analysis (“DMA”) curves may be seen for Compositions B1, B3, B6, and B8 of Table 1. As can be seen, the modulus of Compositions B1, B3, and B8 are higher than the modulus of control Composition B6, a control silicone composition with no added liquid acrylate filler. As the sample temperature is raised, a number of things are apparent:
1) The modulus of Composition B3 falls to that of the control formulation B6 as the temperature is raised from 30° C. to 60° C., with the Tg of trimethylcyclohexyl acrylate being 67° C. This is indicative that the cured liquid acrylate filler is no longer providing the same physical reinforcement and augmentation of physical properties as it had when in the solid state. Once solidified again by cooling, the properties of the total composition will again be enhanced.
2) The modulus of Composition B1 falls to that of control formulation B6 as the temperature is raised from 110° C. to 160° C., with the Tg of isobornyl acrylate being 88° C.; and
3) The modulus of Composition B8 falls close to that of control Composition B4 as the temperature is raised from 130° C. to 170° C., with the Tg of isobornyl methacrylate being 110° C. and the Tg of isobornyl acrylate being 88° C.

The modulus of formulations containing acrylate monomers with low a low Tg, Composition B2 (with the Tg of isodecylacrylate being −60° C.) and Composition B4 (with the Tg of 2-ethylhexyl acrylate being −50° C.), were close to that of the unfilled silicone indicating no reinforcing effect as expected, because the Tg of each of the cured acrylate monomers is well below room temperature.

Compositions B11 and B12 (containing dicyclopentadienyl, with a Tg of 110° C.), did not show transitions within the sensitivity range of the DMA instrument even though the scan range was up to and beyond 150° C. However, as can be seen from the thermo mechanical data in Table 3, the TMA equipment is apparently more suitable for showing these transitions.

The following examples were prepared in accordance with the invention.

### EXAMPLES

TABLE 1A

| Com- | | | | | | | | | | |
|---|---|---|---|---|---|---|---|---|---|---|
| ponent | | | | | | | | | | |
| Liquid | | | | | | | | | | |
| (Meth) | | | | | | | | | | |
| Acry- | | | | | | | | | | |
| late | Composition/Amt. (wt %) | | | | | | | | | |
| Filler | B1 | B2 | B3 | B4 | B5 | B6 | B7 | B8 | B9 | B10 |
| IBOA | 37.0 | | | | | | 18.5 | 31 | | |
| IDOA | | 37.0 | | | | | | | | |
| TCOA | | | 37.0 | | | | | | | |
| EHA | | | | 37.0 | | | | | | |
| IBOMA | | | | | 37.0 | | 18.5 | 6 | | 37 |
| CHMA | | | | | | | | | 37 | |
| DCPA | | | | | | | | | | |
| Silicone | 60 | 60 | 60 | 60 | 60 | 97 | 60 | 60 | 60 | 62.5 |
| Resin | | | | | | | | | | |
| Matrix | | | | | | | | | | |
| Poly- | | | | | | | | | | |
| acrylate | | | | | | | | | | |
| Resin | | | | | | | | | | |
| Matrix | | | | | | | | | | |
| Poly- | | | | | | | | | | |
| ure- | | | | | | | | | | |
| thane | | | | | | | | | | |
| Matrix | | | | | | | | | | |
| Photo- | 3 | 3 | 3 | 3 | 3 | 3 | 3 | 3 | 3 | 0.5 |
| initiator | | | | | | | | | | |

TABLE 1B

| Component | | | | | | |
|---|---|---|---|---|---|---|
| Liquid | | | | | | |
| (Meth)Acrylate | Composition/Amt. (wt %) | | | | | |
| Filler | B11 | B12 | B13 | B14 | B15 | B16 |
| IBOA | | | | 24.72 | | 49.5 |
| IDOA | | | | | | |
| TCOA | | | | | | |
| EHA | | | | | | |
| IBOMA | 37 | | | | | |
| CHMA | | | | | | |
| DCPA | 20.95 | 24.9 | | | | |
| Silicone Resin | 78.57 | 74.71 | | | | |
| Matrix | | | | | | |
| Polyacrylate | | | | | 98.96 | 49.5 |
| Resin Matrix | | | | | | |
| Polyurethane | | | 98.96 | 74.17 | | |
| Matrix | | | | | | |
| Photoinitiator | 0.48 | 0.39 | 1.04 | 1.11 | 1.04 | 1.0 |

IBOA = Isobornyl acrylate
IDOA = Isodecyl acrylate
TCOA = Trimethyl cyclohexyl acrylate
EHA = 2-Ethylhexyl acrylate
IBOMA = Isobornyl methacrylate
CHMA = Cyclohexyl methacrylate
DCPA = Dicyclopentenyl acrylate

Tables 1A and 1B above show Compositions B1-B16 containing typical concentrations of various acrylate monomers useful in the present invention. In each of Compositions B1-B12 the silicone resin matrix is 3-methacryloxydimethoxysilyl-terminated polydimethyl siloxane. In Compositions B13 and B14, the ACRYLFLEX brand polyurethane acrylate matrix is used. Compositions B15 and B16 use a polyacrylate matrix available commercially from Kaneka Corporation under the trade name RC100C. Compositions B6, B13 and B15 do not have the liquid (meth)acrylate filler and are thus presented as controls.

TABLE 2

| | Physical Properties | | |
|---|---|---|---|
| | Tensile Strength | Elongation at Break | Shore A |
| Component | (psi) | (%) | Hardness |
| B1 | 929 | 327 | 40 |
| B2 | 48 | 127 | 7 |
| B3 | 508 | 328 | 35 |
| B4 | x | x | x |
| B5 | 393 | 258 | 23 |
| B6 | 38 | 147 | 3 |
| B7 | 904 | 304 | 35 |
| B8 | 969 | 314 | x |
| B9 | 153 | 198 | x |
| B10 | 522 | 274 | x |
| B11 | 163 | 149 | x |
| B12 | 205 | 166 | 24 |
| B13 | 379.8 | 29.8 | 75 |
| B14 | 544.9 | 64.1 | 72 |
| B15 | 43.8 | 97.6 | 14 |
| B16 | 1784 | 178 | 70 |

Table 2 above shows some of the physical properties of the compositions from Tables 1A and 1B. As is readily apparent, the addition of a variety of liquid (meth)acrylate monomer fillers to various polymer matrices results in substantially improved physical properties, as compared to the control Compositions B6, B13 and B15. In particular, tensile strength, elongation at break and Shore A hardness increase significantly, regardless of the matrix used.

TABLE 3

| Composition | Silicone Tg (° C.) | Acrylate Monomer Tg (° C.) |
|---|---|---|
| B1 | −46.7 | 99.6 |
| B2 | — | — |
| B3 | −45.99 | 41.9 |
| B4 | — | — |
| B5 | — | — |
| B6 | −45 | N/A |
| B7 | — | — |
| B8 | — | — |
| B9 | — | — |
| B10 | — | — |
| B11 | −46.6 | 103 |
| B12 | −46.7 | 90.7 |
| B13 | — | 111 |
| B14 | — | 106.5 |

Table 3 above presents data obtained from thermomechanical analysis of various formulations from Tables 1A and 1B. This technique measures volume change of solid sample as temperature is raised. As the temperature reaches the Tg of the cured acrylate, the acrylate domains soften and create a difference in the rate of expansion of the sample, thus providing evidence for the presence of domains.

Compositions B17 and B18 are additional examples of inventive compositions.

TABLE 4

| Composition | B17 | B18 |
|---|---|---|
| PDMS dual cure* | 72.09 | — |
| PDMS radiation cure** | — | 63.5 |
| Photoinitiator | 0.42 | 1.1 |
| Moisture cure catalyst | 0.1 | 0.05 |
| Stabilizer | 0.01 | — |
| Fumed silica | 9.4 | 8.5 |
| Silane crosslinkers | 0.8 | 1.85 |
| IBOA | 17.18 | 25 |

*Polydimethylsiloxane as a matrix with appropriate functionality which cures when exposed to radiation and/or moisture
**Polydimethylsiloxane as a matrix with appropriate functionality which cures when exposed to radiation

To determine the presence of distinct polymer phases between the cured liquid filler and the cured matrix, AFM was used. AFM performs nanoscale characterization of surfaces. AFM operates akin to a blind person using a cane to walk down the street, in that a probe (the cane) is used to sense protrusions or depressions in a surface (a street), often by tapping the tip against the surface. Not unlike the blind person, additional observations can be made by the same probe, such as the elasticity of the surface (how well the cane bounces back upon tapping) or any frictional effects (e.g. if the probe sticks to the surface). The responses are recorded by a computer as a function of position, just as the blind person imprints his/her path in their memory, providing an accurate map of where the tip has been. The method is distinct from optical microscopy, which provides an instantaneous and broad field of view not unlike when we view the stars at night in the sky with our own eyes. In contrast, the instantaneous field of view for AFM is akin to looking through a telescope—eventually one can obtain the same overall field of view by scanning the scope across the sky, requiring a great deal more time but providing enhanced resolution. In AFM, the probe is positioning and rastered using independent x, y, and z actuators designed with nanoscale accuracy and sub-nanometer noise. The probe itself is a micromanufactured silicon or silicon nitride tip with a radius of curvature at its end (sharpness) of 10 to 100 nanometers. Typical cantilever dimensions are approximately 100×30×1 micrometers in length×width×thickness. Forces ranging from 0.1 to 10,000 nN can be detected between the AFM tip and a surface with a straightforward but sophisticated transduction system. For simple topographic and mechanical studies such as those performed here, these forces are predominantly contact repulsive forces. Essentially, contact between an AFM probe and a surface is detected by reflecting a focused beam of light off of a cantilever integrated with the tip—analogous to a diving board with the tip at its free end. This lever deflects whenever the tip experiences a force; for example, during contact with a surface the lever necessarily bends away from the surface. The light path then changes upon lever deflection, which is detected by a quadrant semiconductor photodetector.

### AFM Procedure

Two distinct sets of measurements were performed and are described herein, those on the initial surface of the as-prepared polymer samples, and those on cross-sections prepared by standard microtome methods. In each case, the specimens were mounted with epoxy on glass slides for AFM imaging and placed in the MFP-3d instrument (manufactured by Asylum Research). The AFM tip (manufactured by Olympus, Model AC-160) was positioned over the surface using an integrated optical microscope, and then multiple scans were performed at various regions on the sample surface. Imaging parameters are always dependent on day-to-day conditions in AFM, but typical details include a tip scanning speed of 10 micrometers per second, image resolution of 256 by 256 pixels (16 bit depth), 1 Volt free amplitude of the tip/lever and setpoint amplitude of 0.8 Volts. Images were acquired with sizes ranging from 1×1 um to more than 50×50 um. The features identified in this study were found to be sub-micron, so 5×5 um images were generally acquired and are presented here as they provide the optimal fine resolution (20 nm/pixel) while simultaneously exhibiting the generality of the observations.

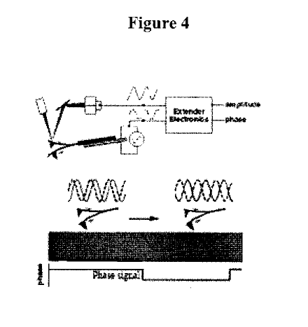

The AFM was operated in the so called “ac” mode (also called “intermittent” or “tapping” modes depending on the AFM manufacturer). In this manner, the AFM tip is not simply rastered across the surface while maintaining constant contact, but rather is repeatedly brought “tapped” against the surface while rastering. Typical ac frequencies range from 60-300 kHz depending on the cantilever, amounting to hundreds of contacts for each data point during scanning (200 taps/pixel for a 100 kHz oscillation during a ½ second scan line of 256 pixels). The primary benefits of using this AC mode is that both the topography, as well as mechanical contrast, can be acquired simultaneously by comparing the phase of the tip/lever response with the oscillating driving signal, FIG. 4. This is easily thought of as the difference between tapping one's finger on a clean table as contrasted to a table covered with something sticky. In the latter case, extra energy is required to pull one's finger away from the surface, as the prove has adhered to the surface. A different, but also applicable example, is that of bouncing a basketball on a gym floor as contrasted to bouncing the basketball on sand. The difference in elasticity between the two surfaces is certainly noticeable—the basketball player has to put more energy into bouncing the ball on the compliant (sandy) surface to get the ball to bounce back into his,her hands. Adhesion, and elasticity, both cause the phase delay between the periodic excitation and the tip/lever response to shift. AFM is frequently applied in this manner to determine the distribution of second phase regions at a surface, since any two distinct phases frequently behave slightly differently in terms of adhesion and/or elasticity. The tip/lever phase therefore shifts whenever the scanning tip encounters a different material, providing maps which can correspond to composition.

### Results

Topography and phase images were acquired on both the two-phase silicone-IBOA samples and the pure silicone control. Results form the surface will first be presented, followed by studies of cross-sectioned samples. All of these results are representative of similar responses obsessed uniformly on each particular sample surface.

### Initial Surface

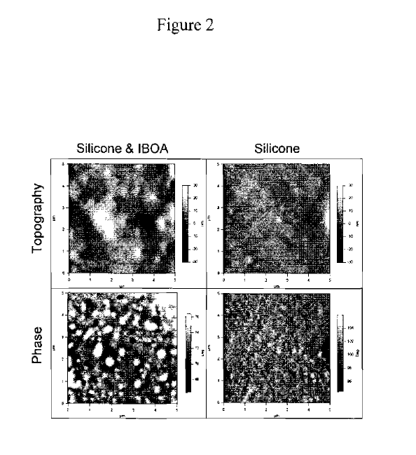

FIG. 2 presents four AFM images of the topography (top) and phase (base) on the two-phase silicone and IBOA sample (left) and the pure silicone control sample (right). Each pair of 5 μm×5 μm topographic and phase images (top and bottom) are acquired simultaneously for the same sample area. The contrast has been adjusted for all images for consistency, such that light to dark in the topographic images indicates physical protrusions or depressions in the surfaces of ±30 nm, respectively. In the phase images, bright to dark indicates ±5° of variation in the phase lead/lag for the oscillating excitation and response signals. As mentioned before, the relative values for phase from one location to another are far more important than the absolute values, since the purpose is to establish a difference in the morphology, not the absolute properties (generally, macroscopic techniques are more suited for that purpose).

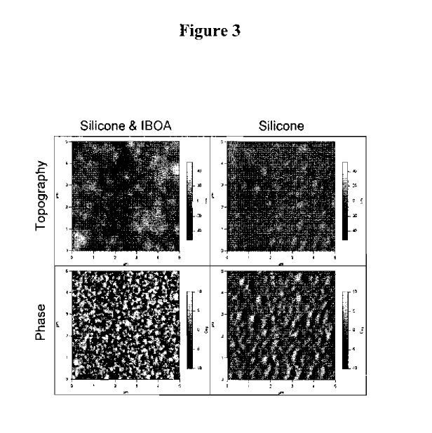

Turning to FIGS. 2 and 3, it is readily apparent that the surface of the two-phase material is significantly different from the control sample. Several features are noteworthy. Regarding topography, both surfaces exhibit occasional protrusions, with heights on the order of 20 nanometers for the silicone and IBOA and 5 nm for the pure silicone. The phase contrast, on the other hand, reveals striking differences, with numerous bright regions that appear to correspond to the topographic protrusions for the silicone and IBOA and negligible phase contrast for the pure silicone control. Of course some contrast is apparent in the phase image for the control sample, but this is simply explained as topographic artifacts caused by changes in the local curvature of the surface. Such artifacts also exist in all AFM images presented in this paper, and indeed in most AFM results, but are generally negligible compared to the strong contrast caused by such effects as a local change in the contact mechanical properties of the tip/sample junction. Accordingly, the profound contrast variations in the silicone and IBOA sample as compared to the pure silicone control can be explained by local changes in the elasticity and/or adhesion of the surface at those locations. These images therefore strongly suggest that the as prepared surface for the silicone and IBOA comprises two distinct material phases with morphology at the nanoscale, while the surface of the pure silicone control is essentially uniform.

### Exposed Cross Sectional Surface

Similar AFM measurements were performed for cross sections of the samples, presented in FIG. 3, which again displays 5 μm×5 μm AFM images of the topography (top) and phase (base) on the silicone and IBOA sample (left) and the pure silicone control sample (right). Here the light to dark topographic contract equates to ±50 nm, while the phase contrast ranges ±10°.

Like the as-prepared surfaces, the cross-sectional surface of the two-phase material is significantly different from the control sample. Several features are noteworthy. Regarding topography, both surfaces exhibit occasional protrusions, with heights on the order of 20 nanometers. The features are also smaller for the 2-phase region, with truly nanoscale structures in the two-phase system as compared to more micron-scale contrast in the control. These differences are even more pronounced in the phase images, though more subtle effects are also apparent upon careful examination. Specifically, although the topographic and phase contrast seem to be correlated, the phase behavior is actually quite distinct. For the 2-phase sample, the phase is essentially bright in a surrounding matrix of grey; each bright spot corresponding to a topographic feature. This suggests of material-phase-separation and a slight protrusion of one component out of the surface with respect to the other. The phase contrast for the control sample also appears to correspond to topographic structures, but with an important difference in that for each feature a gradient of bright to dark exists from left to right. On this surface, significant and constant phase changes traversing any given feature are never observed as for the two component system. If this strange AFM phase contrast on the control cross section were related to the mechanics of the surface, each of these features would by implication be more elastic on one side and less so on the other, and/or more adhesive on one side and less on the other, but always with the same orientation. This symmetry is obviously impossible, and indeed corresponds instead to a common AFM artifact brought on by subtle local changes in the tip-sample contact area when scanning the probe. Such results and interpretations are common in AFM-based studies of similar systems. These observations therefore lead to the conclusion that, just as for the as-prepared materials, the cross-sectional surfaces of the silicone and IBOA exhibit two distinct nanoscale phases with different contact-mechanical properties, whereas the pure silicone surface is comparably uniform.

AFM topography and phase images of the as-prepared surface of silicone and IBOA exhibit nanoscale protrusions with differing contact mechanical properties than the surrounding matrix, suggesting material-phase separation. This is supported in two ways from the perspective of this AFM analysis. First, equivalent images acquired for pure silicone as a control are essentially featureless, as expected where material-phase separation is not expected to occur. Second, similar images of cross sections exposed by microtoming also reveal equivalent structures for the silicone and IBOA sample only, not the control.

What is claimed is:

1. A composition comprising:
a) a silicone component; and
b) a (meth)acrylate monomer present in an amount of at least about 5% by weight of the total composition;
wherein the composition is free of an acylphosphine oxide.

2. The composition of claim 1, wherein the (meth)acrylate monomer is selected from the group consisting of isobornyl acrylate, isooctyl acrylate, isodecyl acrylate, 2(2-ethoxyethoxy)ethylacrylate, adamantyl acrylate, dicyclopentenyl acrylate, trimethylcyclohexyl acrylate, cyclohexyl(meth)acrylate, and combinations thereof.

3. The composition of claim 1, wherein the (meth)acrylate monomer is isobornyl acrylate.

4. The composition of claim 1, further comprising a filler.

5. The composition of claim 1, further comprising a radiation cure catalyst.

6. The reaction product of the composition of claim 5 upon exposure to radiation.

7. The composition of claim 1, further comprising a moisture cure catalyst.

8. The composition of claim 7, further comprising a free radical initiator.

9. The reaction product of the composition of claim 7, produced upon exposure to moisture.

10. A composition comprising:
a) a curable non-(meth)acrylate based polymer matrix; and
b) a liquid (meth)acrylate monomer, which when co-cured with the matrix serves as a solid filler.

11. The composition of claim 10, wherein the non-(meth)acrylate based polymer matrix is selected from the group consisting of polyurethanes, epoxies, polyesters, silicones and mixtures and copolymers thereof.

12. The composition of claim 10, wherein the (meth)acrylate monomer once cured has a Tg greater than about room temperature (23° C.).

13. A composition comprising:
a) a poly(acrylate) matrix; and
b) a liquid (meth) acrylate monomer filler present in amounts of about 5% to about 60% by weight of the total composition.

14. The composition of claim 13, comprising as a first phase a cured poly(acrylate) matrix and having dispersed there a second phase comprising a cured (meth)acrylate monomer.

15. A method of providing structural reinforcement to a composition comprising:
a) providing a liquid (meth)acrylate monomer;
b) providing a curable polymer matrix;
c) combining a) and b) to form a curable composition; and
d) curing the curable composition, whereby at least one of the following properties are increased: tensile strength; elongation at break; tear strength or Shore A hardness.

16. A method of reshaping a cured composition comprising:
a) providing a liquid (meth)acrylate monomer;
b) providing a curable polymer matrix;
c) combining a) and b) to form a curable composition; and curing the curable composition;
d) heating the cured composition to a temperature above the Tg of the monomer but below the Tg of the polymer;
e) changing the shape of the cured composition and maintaining that changed shape until the monomer resolidifies, whereby the cured composition holds its changed shape.
